(19) United States
(12) Patent Application Publication
(10) Pub. No.: US 2002/0145943 A1
(43) Pub. Date: Oct. 10, 2002

(54) E-marker watchband

(76) Inventor: John Tree, London (GB)

Correspondence Address: Seong-Kun Oh, Sierra Patent Group, Ltd., P.O. Box 6149, Stateline, NV, 89449, US

(21) Appl. No.: 09/827,472

(22) Filed: Apr. 6, 2001

(51) Int. Cl. G04B 47/00

(52) U.S. Cl. 368/10

(57) ABSTRACT

An integrated electronic music marker watch device is provided with an electronic marker input unit and a display unit, and configured to display a user's electronic data marks of music clips broadcast over registered radio or television stations responsive to user input commands by illuminating or displaying information on a preassigned section or panel of the display unit such as the watch face in addition to providing time and/or date information as a watch.

### BACKGROUND OF THE INVENTION

1. Field of the Invention

The present invention relates to integrated electronic watch devices. More particularly, the present invention relates to an integrated electronic music marker watch device.

2. Description of the Related Art

With increase in portable electronic devices such as personal digital assistants (PDAs) and WAP (Wireless Application Protocol) enabled mobile telephones, there has been a steady increase in these types of devices capable of performing more operations.

Sony Corporation and its U.S. subsidiary, Sony Electronics, Inc., introduced a so called e-marker which is capable of “bookmarking” a music clip while being played on a radio and is capable of recalling the information related to the bookmarked music clip such as the name of the song, the artist, the album containing the song and so on. Using the e-marker, a user can conveniently access the music clip information that the user listened to on a radio or television broadcast at a later time without the need to memorize the information or wait hopefully for the disc jockey on the radio or the television station to provide that information. In this manner, if the user wants to, for example, purchase the music album which the user has marked using the e-marker, the user can easily identify the necessary information related to the marked music clip from the e-marks provided by the e-marker.

While the e-marker has been introduced as a portable electronic device which can easily fit into a user's hand or slip into a key chain ring or a shirt pocket, with constant increase in the number of items, electronic or not, that people carry around on a daily basis such as keys, cellular phones, watches, and PDAs, it may be desirable to integrate the functionality of the e-marker into a device which most users already use and carry.

### SUMMARY OF THE INVENTION

In one embodiment, an electronic data marker device is integrated into a standard wristwatch and is configured to perform the functions of an e-marker device. In particular, an integrated electronic data marker watch device in one embodiment includes a display unit including a plurality of display panels positioned on the display unit, and an input unit for inputting data marks, the display unit is configured to receive the data marks from the input unit and correspondingly display the data marks on the plurality of display panels. In another embodiment, there is provided a method including receiving a data mark, and displaying the received data mark on a watch face.

These and other features and advantages of the present invention will be understood upon consideration of the following detailed description of the invention and the accompanying drawings.

### BRIEF DESCRIPTION OF THE DRAWINGS

FIG. 1 illustrates one embodiment of a perspective view of an integrated electronic music marker watch device;

FIG. 2 illustrates a front view of the music marker of FIG. 1;

FIGS. 3 and 4 illustrate left and right side views of the music marker of FIG. 1;

FIG. 5 illustrates the music marker display unit of FIG. 1;

FIG. 6 illustrates the music marker display unit of another embodiment;

FIG. 7 illustrates another embodiment of an integrated electronic music marker watch device;

FIG. 8 is a flow chart for illustrating one embodiment of the electronic music marker operation; and

FIG. 9 is a flow chart for illustrating one embodiment of downloading data from the user's e-marker account to the electronic music marker.

### DETAILED DESCRIPTION

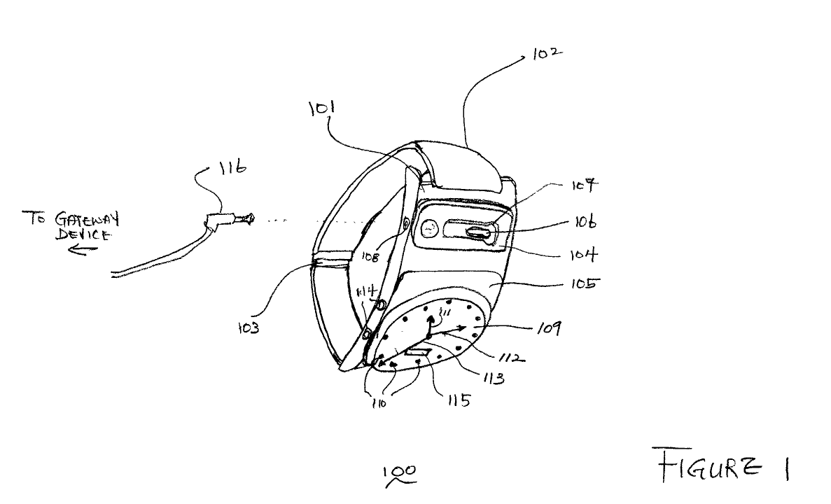

FIG. 1 illustrates one embodiment of a perspective view of an integrated electronic music marker watch device 100. Referring to FIG. 1, integrated electronic music marker watch device 100 includes integrated watch body 101 connected to watch strap 102. Along watch strap 102 is provided watch clasp 103 which may be opened and closed for wearing integrated electronic music marker watch device 100 around a user's wrist. Integrated watch body 101 includes electronic marker unit 104 and display unit 105. Electronic marker unit 104 includes first and second e-buttons 106, 107, respectively, substantially provided on an upper front surface of integrated watch body 101. Additionally, input/output terminal 108 is provided substantially on an upper left side surface of integrated watch body 101 for connection to microjack 116 or other interface device for communication with a gateway device such as a personal computer, a personal digital assistant, a WAP-enabled mobile telephone, a mobile telephone configured to operate under the so-called i-mode for wireless internet connection, or a television set enabled for web-TV internet access.

Further shown in FIG. 1 is display unit 105 provided substantially on a lower front surface of integrated watch body 101. Display unit 105 includes display portion 109 and a plurality of e-mark display panels 110. In one embodiment, each e-mark display panels 110 corresponds to a respective hour mark of a typical analog watch face, while display portion 109 corresponds to the substantially circular watch face itself. For example, e-mark display panel 110 positioned closest to electronic marker unit 104 may be the hour mark indicating the 12 o'clock position. Also provided in display unit 105 are hour, minute and second hands 111, 112, 113, respectively, which typically indicate the time information based on the rotational position of the hour, minute and second hands 111, 112, 113, respectively.

Display unit 105 of integrated watch body 101 also includes a pair of watch control dials 114 provided on a lower left side surface of integrated watch body 101. The pair of watch control dials 114 may be configured to control the movement of hour, minute and second hands 111, 112, 113, respectively, to adjust the time displayed on display unit 105. Moreover, date display portion 115 may be provided in display unit 105 for displaying date information such as day, month and year. In this case, watch control dials 114 may further be configured to control the adjustment of date information for display in date display portion 115.

Each e-mark display panel 110 may be individually configured to be illuminated or turned on for visual display and further, may be configured to provide, in one embodiment, text and image displaying capability responsive to the user's input commands. Indeed, in one embodiment, each e-mark display panel 110 may be configured with separate liquid crystal displays (LCDs) to enable displaying text and image information corresponding to the user's input commands via first and second e-buttons 106, 107 respectively. Moreover, each e-mark display panels 110 may be individually controlled and manipulated based on the user's input commands via first second e-buttons 106, 107, respectively, such that when the user depresses either of first second e-buttons 106, 107, respectively, one of the plurality of e-mark display panels 110 may be configured to display a corresponding information or to illuminate in response to the user's input commands.

In one embodiment, display unit 105 may include one of a liquid crystal display and a touchpad display unit. Additionally, e-mark display panels 110 on the display unit 105 may be provided in a substantially non-overlapping manner with e-mark display panels 110 having substantially the same dimensions, for example, in the shape of a circle, a square, a triangle or a rectangle, arranged substantially equidistant from each other. Of course, within the scope of the present invention, e-mark display panels 110 may each be provided with a unique dimension.

Referring back to FIG. 1, input/output terminal 108 provided on integrated watch body 101 may be configured to connect integrated electronic music marker watch device 100 to a gateway device such as a personal computer or a personal digital assistant (PDA) enabled for internet connection, for transferring data from integrated electronic music marker watch device 100 to a user's e-marker account at e-marker.com web site. In one embodiment, input/output terminal 108 may include a typical port for connection to a micro-jack, an infra red (IR) port, a Bluetooth transfer protocol enabled port, or any other types of available terminals which is compatible with the respective terminal at the gateway device for data communication.

Moreover, in one embodiment, first e-button 106 may be configured to operate in substantially the same manner as the e-button provided on a commercially available e-marker device for marking broadcasts of music clips from registered radio stations, while second e-button 107 may be configured to operate in a substantially similar manner as double clicking the e-button on the e-marker device for marking a music broadcast over a registered television channel. Alternately, first e-button 106 and second e-button 107 may be combined together into a single e-button such that a single depression-type operation of the combined e-button may be configured to mark a music clip broadcast over a registered radio station, while a double click-type operation of the combined e-button may be configured to mark a music clip broadcast over a registered television station. Referring again to FIG. 1, in one embodiment, first and second e-buttons 106, 107, respectively may be mounted to electronic marker unit 104 with a conventional spring-loaded mechanism for user input operations. Alternatively, first and second e-buttons 106, 107, respectively, may be incorporated into electronic marker unit 104 as touch sensitive pads for inputting user input commands.

As will be discussed in further detail below, when integrated electronic music marker watch device 100 is connected to a gateway device such as a personal computer via input/output terminal 108, for example, to connect to the user's e-marker account at the e-marker web site, upon verification of the user's identity corresponding to the e-marker account that the user is attempting to access, information corresponding to the e-marked music clips are displayed in respective e-mark display panels 110. In one embodiment, the displayed information may include text data indicating the name of the marked music clip, the name of the music album of the marked music clip, and the name of the artist, and in combination or separately, an image data illustrating an image of the album for the marked music clip and an image of the artist for the marked music clip. While several different types of data including text, image, and a combination of text and image information is described above for display on each respective e-mark display panels 110, depending on the size of each e-mark display panels 110, all retrieved information may be simultaneously displayed on each e-mark display panel 110.

In operation, when a user wearing integrated electronic music marker watch device 100 hears a radio or television broadcast of a music clip and wishes to mark that particular music clip so that the user may retrieve information related to that music clip at a later point in time or purchase that music clip, the user operates first or second e-buttons 106, 107, respectively. Then, a corresponding e-mark display panel 110 is illuminated indicating that the user has e-marked a particular music piece. In one embodiment, the e-mark display panel 110 may display time and date information of when the user operated first or second e-buttons 106, 107, respectively, in addition to being illuminated.

In this manner, the user may continue to mark music clips that are broadcast over registered radio or television stations, and with user's each operation of first or second e-buttons 106, 107 respectively, to mark particular music clips, a corresponding e-mark display panel 110 is illuminated. In one embodiment, the order in which e-mark display panels 110 are illuminated or “turned-on” responsive to the user's sequential input operation of either of first and second e-buttons 106, 107 respectively, may be serial in a clock wise or a counterclock wise manner starting from a predetermined e-mark display panel 110.

As an example, upon detection of the user's first operation of first or second e-buttons 106, 107, e-mark display panel 110 positioned at 12 o'clock (closest to electronic marker unit 104) may be illuminated or turned on. Thereafter, with each subsequent marking of music clips from various radio and television station broadcasts using first or second e-buttons 106, 107, each adjacent e-mark display panels 110 (counterclock wise or clockwise) may be illuminated or turned on. In this manner, the user may readily ascertain the number of e-marks that the user has input by looking at the display unit 105, thus allowing the user to easily keep track of the number of e-marks of desired music clips heard on radio or television broadcasts. Alternatively, in one embodiment, the sequence of illumination (or turning on) of e-mark display panels 110 may be randomly assigned rather than following a predetermined pattern or order.

Thereafter, when the user connects integrated electronic music marker watch device 100 to a gateway device, and logs onto the user's acount at the e-marker.com web site, the information corresponding to the e-marked music clips stored in integrated electronic music marker watch device 100 are automatically transferred to the user's e-marker account. Additionally, integrated electronic music marker watch device 100 may be configured to receive information corresponding to each e-marked music clip from the e-marker.com web site such that each e-mark display panel 110 may be configured to display the received information corresponding to the particular music clip that the user e-marked. For example, integrated electronic music marker watch device 100 may be configured to receive information corresponding to the marked music clip such as the name of the music piece, the name of the artist, the name of the album for the music piece, and so on. Additionally, integrated electronic music marker watch device 100 may also be configured to receive image data (for example, in the form of .jpg, .gif and other compatible image file formats) corresponding to the marked music piece such as a still image of the album cover for the music piece, a still image of the artist for the music piece for display on the respective e-mark display panels 110. Alternatively, integrated electronic music marker watch device 100 may be configured to receive a short video clip, an animated music video clip corresponding to the e-marked music piece, or a video clip of the artist for the e-marked music piece (for example, in formats such as .mpg, .avi, and so on) for display on the corresponding e-mark display panels 110. In one embodiment, the image data may be concurrently displayed on e-mark display panel 110 with the text data. Alternatively, only video data or text data may be displayed on a particular e-mark display panel 110.

Additional detailed information relating to the operation of the electronic music marker device can be found in pending application Ser. No. 09/126,007 filed on Jul. 29, 1998 and application Ser. No. 09/401,103 filed on Sep. 22, 1999, both assigned to Sony Corporation, joint-assignee of the present application with Sony Electronics, Inc., a subsidiary of Sony Corporation, the disclosures of each of which are herein incorporated in their entirely by reference for all purposes.

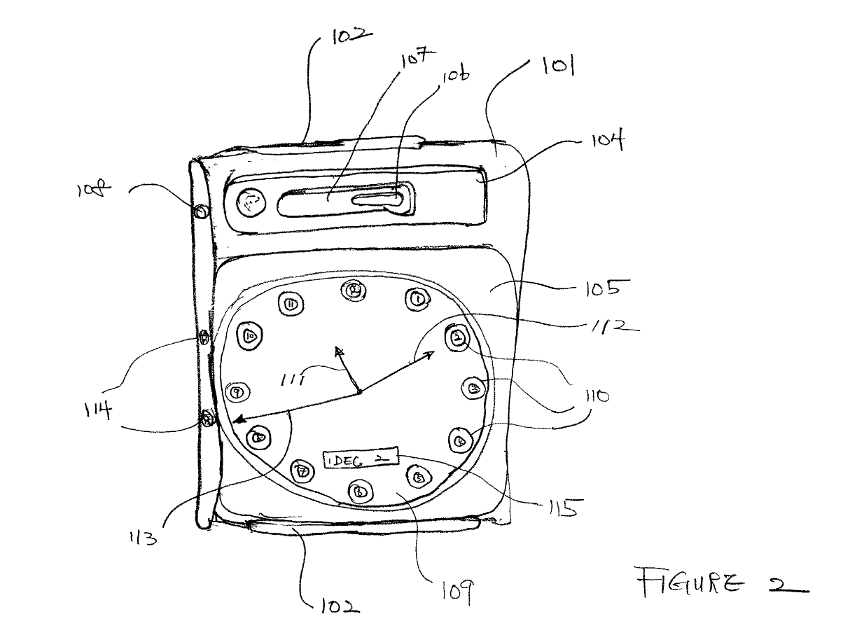

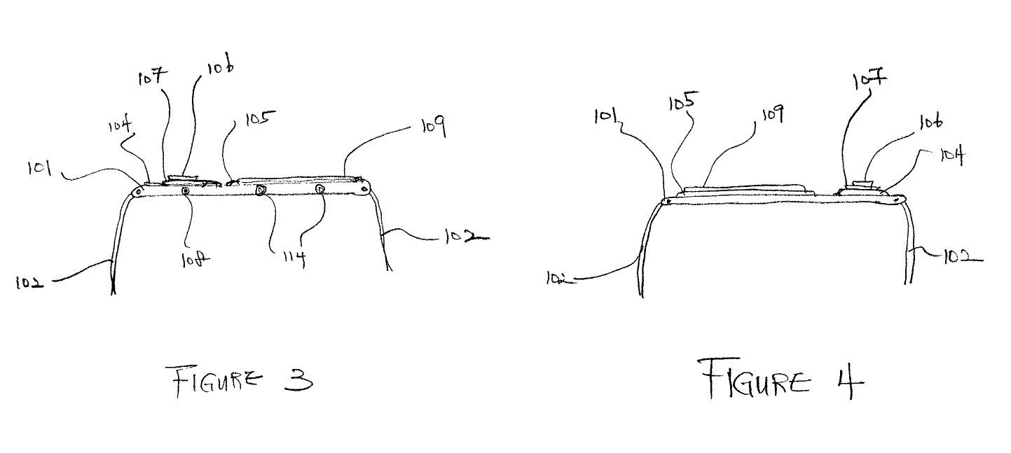

FIG. 2 illustrates a front view of the music marker of FIG. 1, while FIGS. 3 and 4 illustrate left and right side views, respectively, of the music marker device of FIG. 1. Referring to FIG. 2, electronic marker unit 104 and display unit 105 are shown in further detail. As can be seen, in one embodiment, each e-mark display panel 110 is substantially circular in shape and are each positioned within a substantially circular display portion 109 of display unit 105. Furthermore, each of the plurality of e-mark display panels 110 is substantially positioned equidistant from each other along the inner circumference of the substantially circular display portion 109. In this manner, in one embodiment, when the user operates first or second e-buttons 106, 107 to mark a music clip broadcast, a corresponding e-mark display panel 110 may be configured to display a data mark such as information corresponding to the user's operation of first or second e-buttons 106, 107. As discussed above, the respective e-mark display panels 110 may be configured to illuminate when the user operates first or second e-buttons 106, 107, respectively, or may be configured to display data information such as time and date information corresponding to the user's e-button operations.

Referring to FIGS. 3 and 4, as discussed above, input/output terminal 108 may be provided for communication between integrated electronic music marker watch device 100 with a gateway device such as a personal computer connected to the internet. In one embodiment, input/output terminal 108 may be provided on the same side of integrated watch body 101 of integrated electronic music marker watch device 100 as watch control dials 114. Alternatively, input/output terminal 108 may be provided on the opposite side of integrated watch body 101 as watch control dials 114. Additionally, for electronic music marker watch device 100 enabled for wireless communication using IR or Bluetooth ports as input/output terminal 108, for example, the wireless port 108 may be provided on the top surface of integrated watch body 101. In this manner, wireless communication with gateway devices may be achieved without requiring the user to take off integrated electronic music marker watch device 100 or bending the user's wrist into an uncomfortable position to allow data transfer.

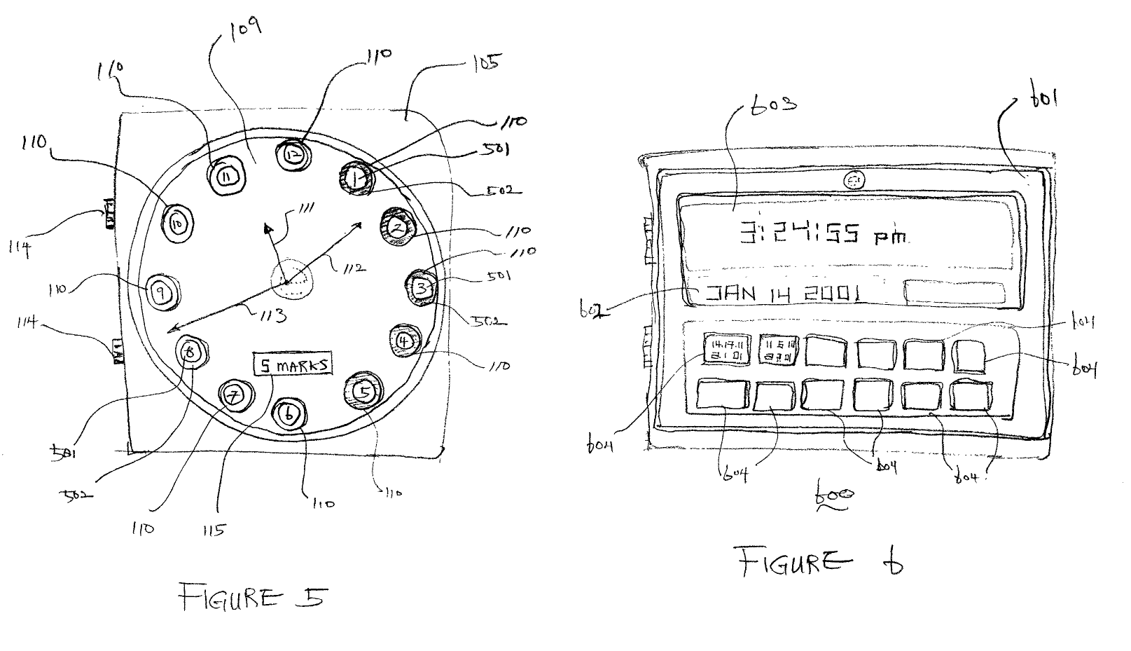

FIG. 5 illustrates the integrated watch face and music marker display unit of FIG. 1. In particular, referring to FIG. 5, display unit 105 of integrated electronic music marker watch device 100 is shown in further detail. As shown, each e-mark display panel 110 includes time display section 501 and e-mark display section 502. As can be seen, time display sections 501 for the respective e-mark display panels 110 may include an alphanumeric number indicative of the hour depending on the position of the corresponding e-mark display panel 110 for the particular time display section 501. In one embodiment, when the user operates first or second e-buttons 106, 107 to bookmark a particular music clip during its broadcast from a registered radio or television station, a corresponding e-mark display section 502 of one of the plurality of e-mark display panels 110 may be configured to illuminate in response thereto. With each subsequent operation of first or second e-buttons 106, 107 by the user, e-mark display sections 502 of the corresponding e-mark display panels 110 may be configured to illuminate. In this manner, the user can determine the number of music clips the user has bookmarked readily with ease from the illuminated e-mark display sections 502 of e-mark display panels 110.

In one embodiment, time display sections 501 for the respective e-mark display panels 110 may not include a corresponding alphanumeric number indicative of the hour. In this case, date display portion 115 may be configured to display the number of music clips bookmarked by the user such that the user does not have to count the number of illuminated e-mark display panels 110 to determine the number of bookmarked music clips. Furthermore, in the case where the number of music clips bookmarked by the user has reached a predetermined maximum number such that electronic music marker watch device 100 may not bookmark additional music clips, display portion 109 may be configured to illuminate for a predetermined time period or to flash a certain number of times when either first or second e-buttons 106, 107 are operated to notify the user that additional music clips may not be bookmarked. Alternatively, in one embodiment, all or a select number of e-mark display panels 110 may be configured to flash a predetermined number of times to notify the user that additional music clips may not be bookmarked and integrated electronic music marker watch device 100 has reached its bookmarking capacity.

FIG. 6 illustrates the integrated watch face and music marker display unit of another embodiment. Referring to FIG. 6, display portion 601 of display unit 600 is provided with a digital interface. In particular, as can be seen from FIG. 6, the date and time information are digitally represented in date display section 602 and time display section 603, respectively. Moreover, e-mark display panels 604 are provided substantially below date display section 602. In this embodiment, in addition to displaying (by illumination or otherwise) e-mark display panels 604 in response to the user's operation of first or second e-buttons 106, 107, it is possible to additionally display information corresponding to each bookmarks such as time and date information of each bookmark in the corresponding e-mark display panels 604.

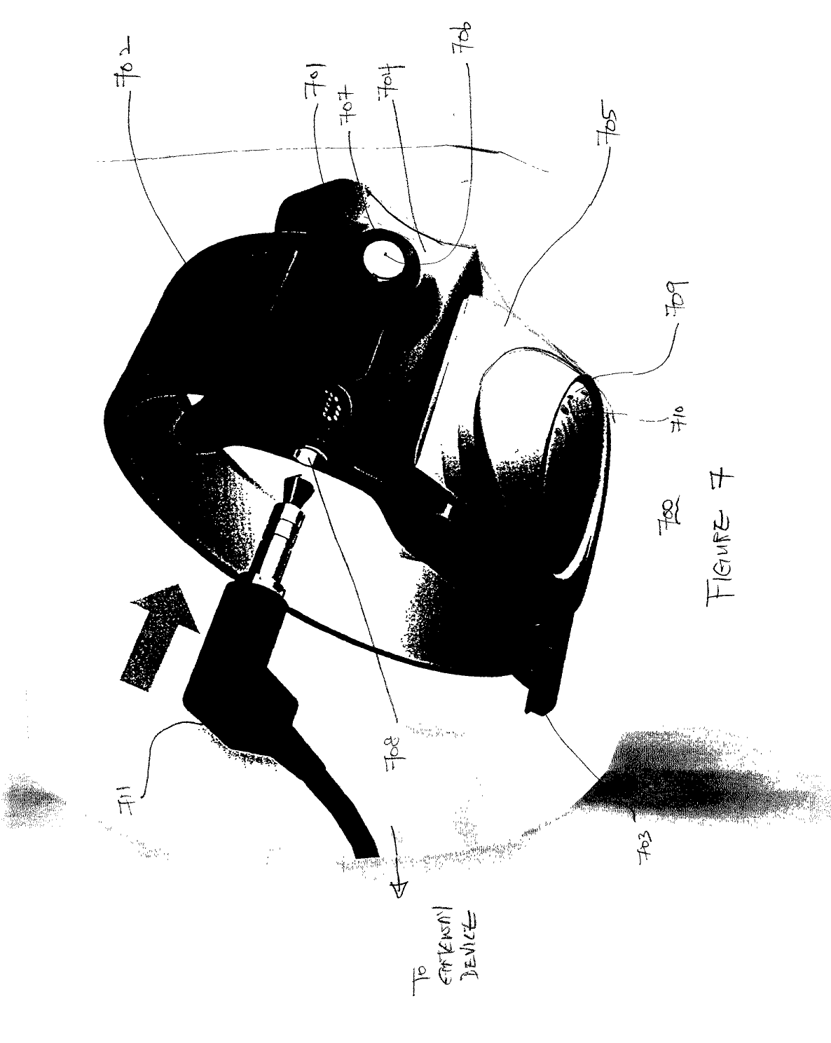

FIG. 7 illustrates another embodiment of integrated electronic music marker watch device 700. Referring to FIG. 7, there is provided integrated watch body 701 including electronic music marker unit 704 and display unit 705. Electronic music marker unit 704 includes first and second e-buttons 706, 707 respectively, for user input commands, while display unit 705 includes display portion 709 having a plurality of e-mark display panels 710. Also shown in FIG. 7 is input/output terminal 708 for connection to a gateway device such as a personal computer via microjack 711 or any other compatible interface device. Additionally, there is provided strap 702 connecting the two ends of the watch body 701 to allow the user to wear the integrated electronic music marker watch device 700 around the user's wrist.

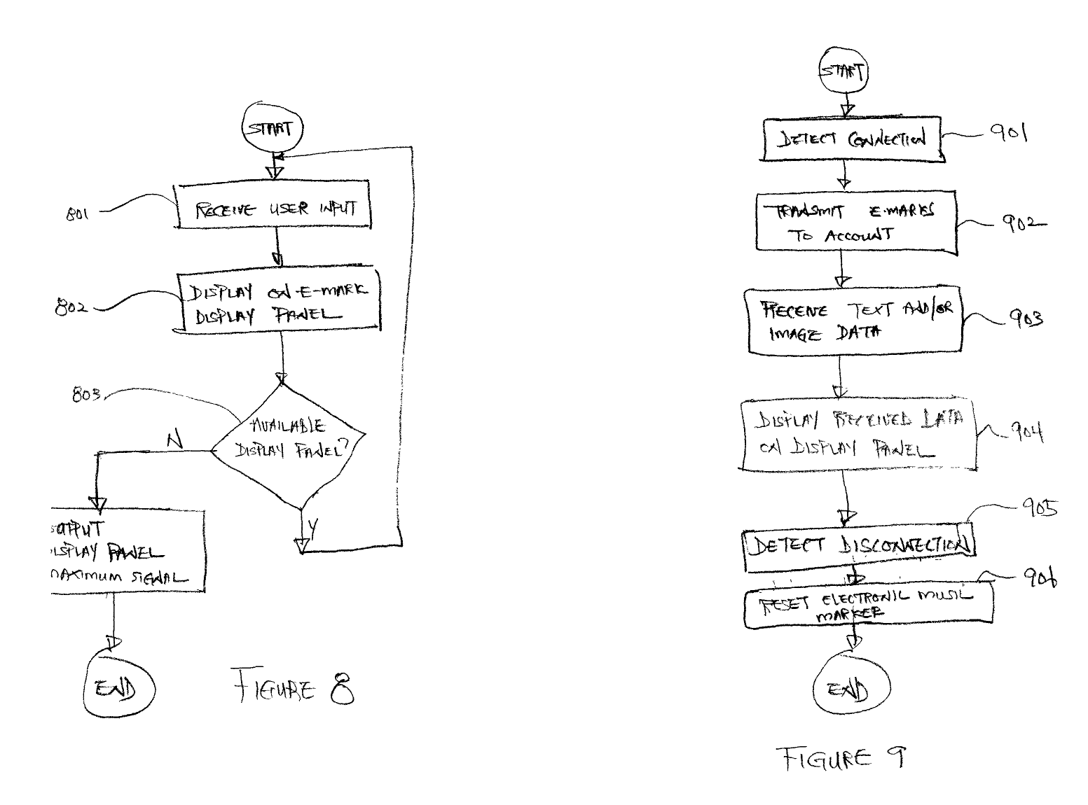

FIG. 8 is a flow chart for illustrating one embodiment of the electronic music marker operation. Referring to FIGS. 1 and 8, at step 801, integrated electronic music marker watch device 100 detects user's input operation of one of first and second e-buttons 106, 107, respectively. Then, at step 802, integrated electronic music marker watch device 100 illuminates a corresponding e-mark display panel 110. As discussed above, in one embodiment, the corresponding e-mark display panel 110 may also display time and/or date information of the user's input operation of first or second e-buttons 106, 107, respectively. Alternatively, the corresponding e-mark display panel 110 may simply illuminate in response to the user's input operation.

At step 803, integrated electronic music marker watch device 100 determines whether all available e-mark display panels 110 are being used (i.e., illuminated in response to user's input operation of first or second e-buttons 106, 107, respectively). If it is determined that there are e-mark display panels 110 available, integrated electronic music marker watch device 100 waits for further input operation by the user at step 801. On the other hand, if it is determined at step 803 that all available e-mark display panels 110 are in use, then at step 804, integrated electronic music marker watch device 100 generates an output signal to inform the user that integrated electronic music marker watch device 100 has reached its maximum number of marks that it can handle, and the procedure ends. In one embodiment, the output signal from integrated electronic music marker watch device 100 to inform the user that it has reached its maximum number of marks it can handle may be an audible signal such as an audible tone via an audio output terminal (not shown). Alternatively, integrated electronic music marker watch device 100 may be configured to illuminate display portion 109 or to flash all e-mark display panels 110 simultaneously for a predetermined period of time to visually indicate to the user that it has reached its maximum number of e-marks that it can handle.

FIG. 9 is a flow chart for illustrating one embodiment of uploading and downloading data between the user's e-marker account and integrated electronic music marker watch device 100 via a gateway device. Referring to FIGS. 1 and 9, at step 901, integrated electronic music marker watch device 100 detects a connection to a gateway device such as a personal computer connected to the internet. After the user enters the user's account information and performs the necessary e-marker account access steps at the gateway device, at step 902, data corresponding to the e-marks stored in integrated electronic music marker watch device 100 is transmitted to the user's e-marker account via the gateway device, and in response, the corresponding text and/or image (including video) data are retrieved from a server terminal of e-marker.com's web site and transmitted to the user's e-marker account. Then, at step 903, the text and/or image data corresponding to each e-marks are downloaded onto integrated electronic music marker watch device 100. At step 904, the downloaded text and/or image data are displayed on each corresponding e-mark display panel 110 on integrated electronic music marker watch device 100.

When the user disconnects integrated electronic music marker watch device 100 from the gateway device, the termination of the connection between integrated electronic music marker watch device 100 and the gateway device is detected at step 905. Then, at step 906, integrated electronic music marker watch device 100 is reset such that previously stored e-marks inputted by the user may be erased from integrated electronic music marker watch device 100, and correspondingly, the illuminated e-mark display panels 110 are turned off. The user may then operate first and second e-buttons 106, 107, respectively, again to input additional e-marks of music broadcasts from registered radio and television broadcast stations.

In the manner described above, an integrated electronic music marker watch device is provided with the functionality of an e-marker device integrated into a watch such that a user wearing the watch can conveniently bookmark desired music clips broadcast over a registered radio or television station using the integrated electronic music marker watch device.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An integrated electronic data marker watch device, comprising:
a display unit including a plurality of display panels positioned on said display unit; and
an input unit for inputting data marks, said display unit is configured to receive said data marks from said input unit and correspondingly display said data marks on said plurality of display panels.

2. The device of claim 1 wherein said display unit includes a time display portion for displaying a time information.

3. The device of claim 1 wherein said display unit includes one of a liquid crystal display and a touchpad display unit.

4. The device of claim 1 further including a strap connected to said display unit.

5. The device of claim 1 wherein each of said plurality of display panels on said display unit is non-overlapping.

6. The device of claim 1 wherein each of said plurality of panels has substantially the same dimensions.

7. The device of claim 6 wherein said plurality of display panels are positioned on said display unit with substantially the same distance therebetween.

8. The device of claim 6 wherein each of said plurality of display panels are one of a circular shape, square shape, a triangular shape, and a rectangular shape.

9. The device of claim 1 wherein said display unit is configured to selectively display an indication of said received data marks on a corresponding one of said plurality of display panels.

10. The device of claim 9 wherein said display unit displays said indication of received data marks by illuminating said corresponding one or more of said plurality of display panels.

11. The device of claim 1 wherein said data marks include data corresponding to a broadcast of a music file.

12. The device of claim 11 wherein said data corresponding to said broadcast of said music file includes a time and date information of said music file broadcast.

13. The device of claim 1 wherein said input unit includes one of a spring loaded button and a touchpad input panel.

14. The device of claim 1 wherein said input unit includes a music broadcast mark button and a television broadcast mark button.

15. The device of claim 1 further including a terminal for coupling to an external device.

16. The device of claim 15 wherein said output unit includes one or more of an infra red (IR) port, a Bluetooth port, and a microjack terminal.

17. The device of claim 15 wherein said external device includes one or more of a personal computer, a personal digital assistant, a television set, a mobile telephone, a pager, and a wireless communication device.

18. The device of claim 15 wherein said external device is configured to correspondingly display said received data marks on said external device.

19. The device of claim 18 wherein said data marks are music marks corresponding to music files and further, wherein said data marks displayed on said external device includes information corresponding to said each received music marks.

20. The device of claim 19 wherein said music marks displayed by said external device includes one or more of a title of the music corresponding to said each music marks, a name of the artist corresponding to each music marks, a title of the album corresponding to each music marks, and a graphical display of an album cover corresponding to each music marks.

21. A method, comprising:
receiving a data mark; and
displaying the received data mark on a watch face.

22. The method of claim 21 further including:
determining that maximum number of data marks have been received; and
outputting an output signal responsive to said determining step.

23. The method of claim 22 wherein said output signal includes one of an audio signal and a display signal.

24. The method of claim 22 wherein said maximum number is twelve.

25. The method of claim 21 wherein said step of displaying said data mark includes illuminating a display panel on said watch face corresponding to the receiving step.

26. The method of claim 21 wherein said data marks include one or more of a time stamp information and a date stamp information.

27. A method, comprising:
detecting a connection to a gateway device;
transmitting stored data marks to said gateway device;
receiving data corresponding to said data marks; and
displaying said received data.

28. The method of claim 27 further including:
detecting a disconnection from said gateway device; and
resetting said stored data marks.

29. The method of claim 28 wherein the resetting step includes deleting the stored data marks.

30. The method of claim 27 wherein said connection includes one of a cable connection and a wireless connection.

31. The method of claim 27 wherein said gateway device includes one of a personal computer and a server terminal.

32. The method of claim 27 wherein said received data includes one or more of text data, still image data, animated image data, and video data corresponding to the stored data marks.

33. An integrated electronic data marker watch device, comprising:
input means for inputting a plurality of data marks; and
display means for displaying a plurality of data marks, said display means configured to display said data marks received from said input on corresponding display panels.
